(19) United States
(12) Patent Application Publication
(10) Pub. No.: US 2026/0322596 A1
(43) Pub. Date: Oct. 15, 2026

(54) Method and Apparatus for Communications with Post-Quantum Cryptography

(71) Applicant: HUAWEI TECHNOLOGIES CO., LTD., Shenzhen (CN)

(72) Inventors: Chitra Javali, Singapore (SG); Faye Liu, Singapore (SG); Yamin Liu, Singapore (SG)

(73) Assignee: HUAWEI TECHNOLOGIES CO., LTD., Shenzhen (CN)

(21) Appl. No.: 19/687,553

(22) Filed: May 26, 2026

Related U.S. Application Data
(63) Continuation of application No. PCT/CN2023/134434, filed on Nov. 27, 2023.

(51) Int. Cl. H04L 9/08; H04L 9/06; H04L 9/32

(52) U.S. Cl. CPC H04L 9/0852; H04L 9/0618; H04L 9/3242

(57) ABSTRACT

A method comprises determining multiple first keys and multiple first ciphertexts based on one or more public keys and multiple key encapsulation algorithms, wherein the multiple key encapsulation algorithms comprise at least one post-quantum cryptography (PQC) algorithm, and wherein the multiple first keys are in one-to-one correspondence with the multiple first ciphertexts; determining a second key based on the multiple first keys; determining a second ciphertext by concatenating the multiple first ciphertexts; determining a third ciphertext and a first message authentication code (MAC) tag value based on the second key and a subscription permanent identifier (SUPI) of the first device; determining a subscription concealed identifier (SUCI) of the first device, wherein the SUCI comprises the second ciphertext, the third ciphertext, and the first MAC tag value; and outputting the SUCI.

### CROSS-REFERENCE TO RELATED APPLICATION

This is a continuation of International Patent Application No. PCT/CN2023/134434 filed on Nov. 27, 2023, the disclosure of which is hereby incorporated by reference in its entirety.

### TECHNICAL FIELD

Embodiments of the present disclosure relate to the field of wireless technologies, and more specifically, to a method and an apparatus for communications with post-quantum cryptography (PQC).

### BACKGROUND

The public key encryption scheme forms an integral part of communication protocols. Generally, Diffie-Hellman and Rivest-Shamir-Adleman (RSA) are public key algorithms used in the public key encryption scheme. The security of these public key algorithms is based on integer factorization or discrete logarithm log problems. The advancement in quantum computers is expected to pose a threat to the public key encryption scheme and would be solvable.

The public key encryption scheme is used to identify a subscriber to the core network in fifth generation (5G) systems before establishing a key. In 5G authentication and key agreement (AKA), a user equipment (UE) generates a subscription concealed identifier (SUCI) from its subscription permanent identifier (SUPI) using the public key encryption scheme based on a home network (HN) public key. If the public key encryption scheme used were broken, the user could be deanonymized. An attacker in possession of the HN public key could calculate the private key in advance of a connection, allowing immediate calculation of the SUPI encryption key when the UE public key is seen. In this case, the public key encryption scheme would offer no privacy protection for the subscriber. Moreover, the public key encryption scheme is vulnerable to post-quantum threats.

### SUMMARY

Embodiments of the present disclosure provide a method and an apparatus for communications with PQC to provide the privacy of a subscriber in a post-quantum safe communication.

According to a first aspect, an embodiment of the present disclosure provides a method for communications with PQC, and the method could be performed by a first device for encryption. Unless otherwise specified, the first device may refer to the first device itself or an apparatus that supports the function of the first device.

The method includes obtaining one or more public keys of a home network to which the first device belongs; determining multiple first keys and multiple first ciphertexts based on the one or more public keys and multiple key encapsulation algorithms, where the multiple key encapsulation algorithms include at least one PQC algorithm, the multiple first keys are in one-to-one correspondence with the multiple first ciphertexts, and each of the multiple first ciphertexts is encrypted based on the corresponding first key; determining a second key based on the multiple first keys; determining a second ciphertext by concatenating the multiple first ciphertexts; determining a third ciphertext and a first message authentication code (MAC) tag value based on the second key and a SUPI of the first device; determining a SUCI of the first device, where the SUCI includes identifiers of the one or more public keys, the second ciphertext, the third ciphertext and the first MAC tag value; and outputting the SUCI.

According to the method above, a second key can be derived based on multiple first keys from multiple different key encapsulation algorithms. Combining multiple different key encapsulation algorithms can be secure as long as one of the multiple different key encapsulation algorithms is secure. Therefore, the method above is helpful to provide privacy in a post-quantum environment. Moreover, the multiple key encapsulation algorithms include at least one quantum-safe algorithm so that the method above can secure the SUPI encapsulation at the first device from quantum attacks.

With reference to the first aspect, in some embodiments, the one or more public keys include multiple different public keys.

With reference to the first aspect, determining a second key based on the multiple first keys includes determining the second key by processing the multiple first keys with a first function, where the first function includes at least one of the following functions: a hash function, a concatenation function or a pseudo-random function (PRF).

According to this embodiment, a general approach to derive the second key based on multiple first keys from multiple different key encapsulation algorithms is provided. This embodiment is helpful to provide privacy in a post-quantum environment.

With reference to the first aspect, in some embodiments, determining a second key based on the multiple first keys includes determining the second key based on the multiple first keys and the multiple first ciphertexts.

According to this embodiment, the second key is derived with an approach where the multiple first keys and the multiple first ciphertexts from multiple different key encapsulation algorithms are used. This embodiment is helpful to provide privacy in a post-quantum environment.

With reference to the first aspect, in some embodiments, determining the second key based on the multiple first keys and the multiple first ciphertexts includes hash concatenating of each of the multiple first keys and its corresponding first ciphertext to obtain multiple hash results; and determining the second key by concatenating the multiple hash results.

According to this embodiment, the second key is derived with an approach where the multiple first keys and the multiple first ciphertexts from multiple different key encapsulation algorithms are hash concatenated. This embodiment is helpful to provide privacy in a post-quantum environment.

With reference to the first aspect, in some embodiments, the SUCI further includes a second MAC tag value for verifying the second ciphertext, and the method further includes determining the second MAC tag value based on the second ciphertext.

According to this embodiment, as the second ciphertext can be verified based on the second MAC tag value, this embodiment can provide a better privacy in a post-quantum environment.

With reference to the first aspect, in some embodiments, the SUCI further includes a protection scheme identifier indicating a first protection scheme, where the first protection scheme is a PQC protection scheme or a PQC hybrid algorithm protection scheme, and outputs of the first protection scheme include the second ciphertext, the third ciphertext and the first MAC tag value.

With reference to the first aspect, in some embodiments, the SUCI further includes a second MAC tag value for verifying the second ciphertext, and the outputs of the first protection scheme further include the second MAC tag value.

With reference to the first aspect, in some embodiments, an elementary file for universal subscriber identity module service table (EF_{UST}) of the first device includes a first service, where a value of the first service indicates that the first device supports PQC SUCI service.

With reference to the first aspect, in some embodiments, the EF_{UST} further includes a second service, where a value of the second service is used to indicate whether the first device supports performing calculation of the PQC SUCI service by universal subscriber identity module (USIM).

With reference to the first aspect, in some embodiments, determining a third ciphertext and a first MAC tag value based on the second key and a SUPI of the first device includes deriving a third key and a fourth key from the second key; determining the third ciphertext by encrypting the SUPI of the first device with the third key; and determining the first MAC tag value based on the third ciphertext and the fourth key.

According to this embodiment, the second key could be input to a key derivation function and the procedure of symmetric key encryption could remain similar to the procedure in current elliptic curve integrated encryption scheme (ECIES)-based SUPI encryption. This embodiment is helpful to provide privacy in a post-quantum environment.

With reference to the first aspect, in some embodiments, the first device is a UE.

According to a second aspect, an embodiment of the present disclosure provides a communication method, and the method could be performed by a second device for decryption. Unless otherwise specified, the second device may refer to the second device itself or an apparatus that supports the function of the second device.

The second aspect provides a Subscriber Identity de-concealing method corresponding to the Subscriber Identity concealing method provided in the first aspect. The technical effect of the second aspect or any one of its embodiments can refer to the technical effect of the first aspect or the corresponding embodiment, and will not be repeated in the second aspect.

The method includes obtaining a SUCI of a first device, where the SUCI includes identifiers of one or more public keys of a home network to which the first device belongs, a second ciphertext, a third ciphertext and a first MAC tag value, where the second ciphertext includes multiple first ciphertexts; determining multiple first keys based on one or more private keys, the multiple first ciphertexts, and multiple key decapsulation algorithms, where the multiple key decapsulation algorithms include at least one PQC algorithm, and the one or more private keys correspond to the identifiers of the one or more public keys; determining a second key based on the multiple first keys; determining a third MAC tag value based on the second key and the third ciphertext; verifying the third ciphertext by comparing the first MAC tag value with the third MAC tag value; and when the third ciphertext is verified successfully, determining a SUPI of the first device based on the second key and the third ciphertext.

With reference to the second aspect, in some embodiments, the one or more public keys include multiple different public keys, and accordingly the one or more private keys include multiple different private keys.

With reference to the second aspect, in some embodiments, determining a second key based on the multiple first keys includes determining the second key by processing the multiple first keys with a first function, where the first function includes at least one of the following functions: a hash function, a concatenation function or a PRF.

With reference to the second aspect, in some embodiments, determining a second key based on the multiple first keys includes determining the second key based on the multiple first keys and the multiple first ciphertexts.

With reference to the second aspect, in some embodiments, determining the second key based on the multiple first keys and the multiple first ciphertexts includes hash concatenating of each of the multiple first keys and its corresponding first ciphertext to obtain multiple hash results; and determining the second key by concatenating the multiple hash results.

With reference to the second aspect, in some embodiments, the SUCI further includes a second MAC tag value for verifying the second ciphertext, and the method further includes determining a fourth MAC tag value based on the second ciphertext received in the SUCI; and verifying the second ciphertext by comparing the second MAC tag value with the fourth MAC tag value.

With reference to the second aspect, in some embodiments, the SUCI further includes a protection scheme identifier indicating a first protection scheme, where the first protection scheme is a PQC protection scheme or a PQC hybrid algorithm protection scheme, and outputs of the first protection scheme include the second ciphertext, the third ciphertext and the first MAC tag value.

With reference to the second aspect, in some embodiments, the SUCI further includes a second MAC tag value for verifying the second ciphertext, and the outputs of the first protection scheme further include the second MAC tag value.

With reference to the second aspect, in some embodiments, the method further includes deriving a third key and a fourth key from the second key; where determining a SUPI of the first device based on the second key and the third ciphertext includes determining the SUPI by decrypting the third ciphertext with the third key; and determining a third MAC tag value based on the second key and the third ciphertext includes determining the third MAC tag value based on the fourth key and the third ciphertext.

With reference to the second aspect, in some embodiments, the first device is a UE and/or the second device is any one of unified data management (UDM), authentication credential repository and processing function (ARPF), or subscription identifier de-concealing function (SIDF).

According to a third aspect, an embodiment of the present disclosure provides an apparatus that is configured to implement the methods provided by the above-mentioned aspects or their embodiments. Further, the apparatus may include units and/or modules, such as a processing unit and/or a communication unit, for the execution of any of the methods provided by the above-mentioned aspects or their embodiments.

In an embodiment of the third aspect, the apparatus is the first device or the second device. When the apparatus is the first device or the second device, the communication unit may be a transceiver, or an input/output interface, or a communication interface. The processing unit may be at least one processor. In an embodiment, the transceiver is a transmitting and receiving circuit. In an embodiment, the input/output interface is an input/output circuit.

In another embodiment of the third aspect, the apparatus is a chip, a system on a chip or a circuit in the first device or the second device. When the apparatus is a chip, a system on a chip or a circuit in the first device or the second device, the communication unit may be an input/output interface, an interface circuit, an output circuit, an input circuit, a pin or a related circuit on the chip, the system on a chip or the circuit. The processing unit may be at least one processor, processing circuit or logic circuit, etc.

According to a fourth aspect, an embodiment of the present disclosure provides an apparatus, and the apparatus includes one or more processors, where the one or more processors are configured to execute a computer program stored in a memory to implement any of the methods provided by the above-mentioned aspects or their embodiments.

In an embodiment of the fourth aspect, the apparatus further includes the memory.

In an embodiment of the fourth aspect or any one of the embodiments of the fourth aspect, the apparatus is the first device or the second device.

In another embodiment of the fourth aspect or any one of the embodiments of the fourth aspect, the apparatus is a chip, a system on a chip or a circuit in the first device or the second device.

According to a fifth aspect, an embodiment of the present disclosure provides an apparatus, and the apparatus includes at least one processor and a communication interface, where the at least one processor is used to obtain a computer program or instructions stored in a memory through the communication interface to implement any of the methods provided by the above-mentioned aspects or their embodiments. The communication interface can be implemented by hardware or software.

In an embodiment of the fifth aspect, the apparatus further includes the memory.

According to a sixth aspect, an embodiment of the present application provides a processor which is configured to execute a computer program stored in a memory to implement any of the methods provided by the above-mentioned aspects or their embodiments.

According to a seventh aspect, an embodiment of the present disclosure provides a computer-readable medium on which a program is recorded, where the program, when executed, enables a computer to implement any of the methods provided by the above-mentioned aspects or their embodiments.

According to an eighth aspect, an embodiment of the present disclosure provides a computer program product, where the computer program product includes instructions to implement any of the methods provided by the above-mentioned aspects or their embodiments.

According to a ninth aspect, an embodiment of the present disclosure provides a computer program, where the computer program, when executed, enables a computer to implement any of the methods provided by the above-mentioned aspects or their embodiments.

According to a tenth aspect, an embodiment of the present disclosure provides a chip, where the chip includes at least one processor and a communication interface, where the at least one processor is used to obtain a computer program or instructions stored in a memory through the communication interface to implement any of the methods provided by the above-mentioned aspects or their embodiments. The communication interface can be implemented by hardware or software.

In an embodiment of the tenth aspect, the chip further includes the memory.

When the method provided in this disclosure is executed by a chip, this application does not limit the number of chips for implementing the method. For example, the method may be executed by one chip, or the method may be executed by two or more chips. In addition, when the number of chips is two or more, there is no limitation on the chip manufacturers, which can be the same manufacturer or different manufacturers.

According to an eleventh aspect, an embodiment of the present disclosure provides a communication system, where the communication system includes a communication apparatus used to perform the method according to the first aspect or its embodiments; and/or, a communication apparatus used to perform the method according to the second aspect or its embodiments.

### DESCRIPTION OF DRAWINGS

One or more embodiments are exemplarily described by corresponding accompanying drawings, and these exemplary illustrations and accompanying drawings constitute no limitation on the embodiments. Elements with the same reference numerals in the accompanying drawings are illustrated as similar elements, and the drawings are not limited to scale, in which:

FIG. 1 is a schematic diagram of a communication system to which the embodiments of this disclosure are applicable.

FIG. 2 is a schematic diagram of an SUCI structure.

FIG. 3 is a schematic diagram of ECIES-based SUPI encryption at a UE.

FIG. 4 is a schematic diagram of ECIES-based SUPI decryption at an HN.

FIG. 5 is a schematic diagram of a key encapsulation mechanism (KEM).

FIG. 6 is a schematic diagram of a communication method 600.

FIG. 7 is a schematic diagram of a relationship between the specific embodiments and the method 600.

FIG. 8 is a schematic diagram of concealing with concatenation using two KEMs at a UE.

FIG. 9 is a schematic diagram of concealing with hash concatenation using two KEMs at a UE.

FIG. 10 is a schematic diagram of concealing with the general approach at a UE.

FIG. 11 is a schematic diagram of an updated Scheme Output.

FIG. 12 is a schematic diagram of a new SUCI structure.

FIG. 13 is a schematic diagram of a communication method 1300.

FIG. 14 is a schematic diagram of a relationship between the specific embodiments and the method 1300.

FIG. 15 is a schematic diagram of SUCI de-concealing with two KEMs at an HM.

FIG. 16 is a schematic diagram of another SUCI de-concealing with two KEMs at an HM.

FIG. 17 is a schematic diagram of a general SUCI de-concealing with two KEMs at an HM.

FIG. 18 is a schematic diagram of an apparatus provided by the embodiments of this disclosure.

FIG. 19 is a schematic diagram of another apparatus provided by the embodiments of this disclosure.

FIG. 20 is a schematic diagram of a chip system provided by the embodiments of this disclosure.

### DESCRIPTION OF EMBODIMENTS

In order to understand features and technical contents of embodiments of the present disclosure in detail, implementations of the embodiments of the present disclosure will be described in detail below with reference to the accompanying drawings, and the attached drawings are only for reference and illustration purposes, and are not intended to limit the embodiments of the present disclosure. In the following technical descriptions, for ease of explanation, numerous details are set forth to provide a thorough understanding of the disclosed embodiments.

The embodiments of the present disclosure can be applied to various communication systems, such as 5G or new radio (NR) systems, Long-Term Evolution (LTE) systems, LTE frequency-division duplex (FDD) systems, LTE time-division duplex (TDD) systems, Universal Mobile Telecommunication System (UMTS), Worldwide Interoperability for Microwave Access (WiMAX) systems, public land mobile network (PLMN), wireless local area network (WLAN) systems, satellite communication systems, sixth generation (6G) mobile communication systems, future communication systems, or a combination of multiple systems above. The embodiments of the present disclosure can also be applied to device-to-device (D2D) communication systems, vehicle-to-everything (V2X) communication systems, machine-to-machine (M2M) communication systems, machine-type communication (MTC) systems, and Internet of things (IoT) communication systems, uncrewed aerial vehicle (UAV) communication systems or other communication systems.

For ease of understanding the embodiments of the present disclosure, a communication system shown in FIG. 1 is firstly used as an example to describe in detail a communication system to which the embodiments of this disclosure are applicable.

Referring to FIG. 1, as an illustrative example without limitation, a simplified schematic illustration of a communication system is provided. The communication system 100 includes three parts, namely a terminal device part, a data network (DN) part and an operator network part. The terminal device can also be referred to as a UE.

The terminal device is a device with a wireless transceiver function that can communicate with one or more core network (CN) devices via an access network device (or access device) in a radio access network (RAN). The embodiments of this disclosure do not limit the specific technology and the specific equipment form used by the terminal device.

The DN, also known as a packet data network (PDN), is usually a network outside the operator network, such as a third-party network. Of course, in some implementations, the DN can also be deployed by the operator. A variety of services can be deployed on the DN to provide data and/or voice services to the terminal device. The operator network includes, but is not limited to, a (radio) access network (R)AN and a core network (CN). The (R)AN can be regarded as a sub-network of the operator network and an implementation system between service nodes and the terminal device. To access the operator network, the terminal device first accesses the (R)AN, and then connects to the service nodes of the operator network through the (R)AN. The embodiments of this disclosure do not limit the specific technology and the specific equipment form used by the access network device. The CN includes, but is not limited to, the following network functions (NF): a user plane function (UPF), a network exposure function (NEF), a network repository function (NRF), a policy control function (PCF), a UDM, a unified data repository (UDR), an access and mobility management function (AMF), a session management function (SMF), and an application function (AF).

It should be understood that the network architecture shown above is only an illustrative illustration and is not limited to the network architecture applicable to the embodiments of this disclosure. Any network architecture capable of realizing the functions of each of the above network elements is applicable to the embodiments of this disclosure.

Related technologies and concepts are introduced here firstly in order to have a better understanding of the technical solution proposed by the present disclosure.

### (1) SUPI

In 5G systems, a serving network uses an SUPI to authenticate a UE and establish a key agreement between the UE and the serving network. The SUPI is a global unique identifier used to authenticate a subscriber and is stored in a UDM or a UDR, and a USIM.

An SUPI consists of:
an international mobile subscriber identity (IMSI); or
if the SUPI is not an IMSI, a non-IMSI-based network access identifier (NAI).

The UE does not transmit the SUPI in clear and the SUPI is concealed to a temporary identifier SUCI. The UE generates the SUCI and transmits the SUCI to a UDM for initial registration. Upon receipt of the SUCI, the SIDF located at the ARPF or the UDM performs de-concealment of the SUPI from the SUCI. Based on the SUPI, the UDM or ARPF chooses an authentication method according to the subscription data.

### (2) SUCI Structure

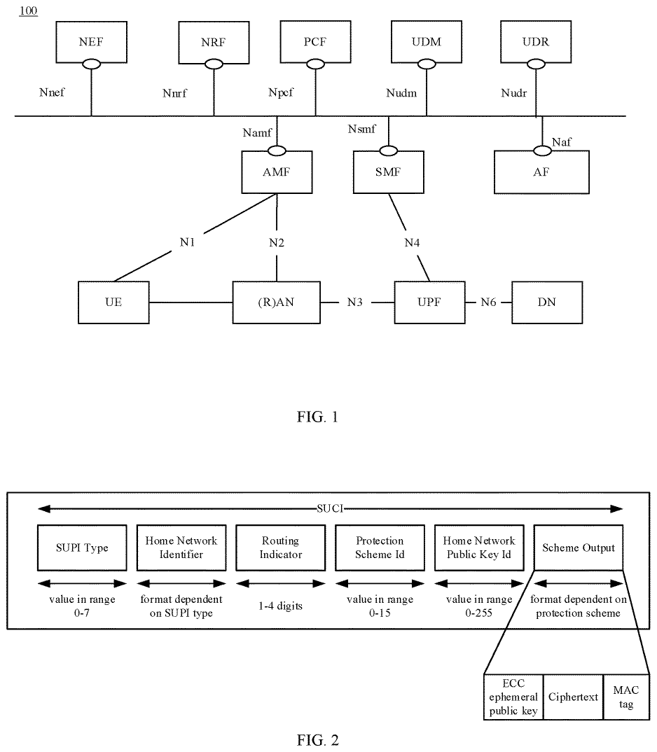

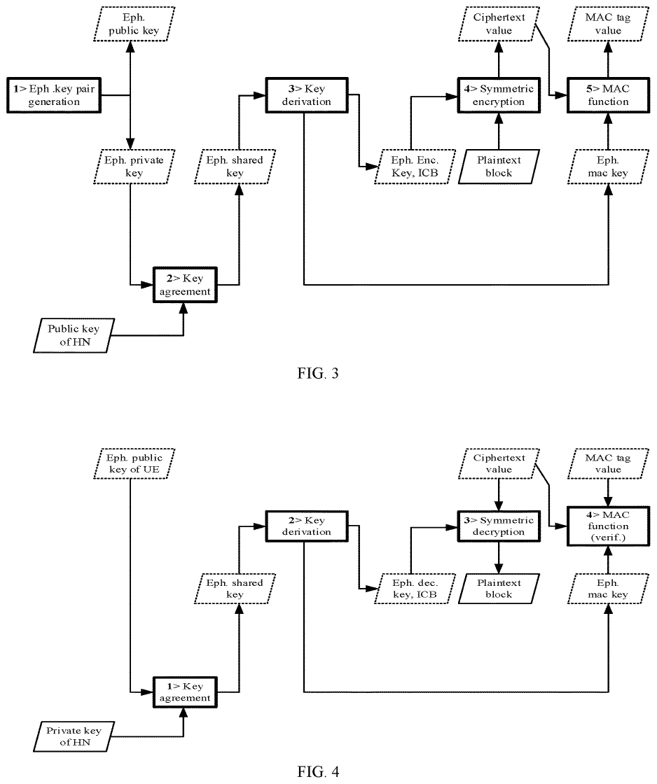

FIG. 2 shows the SUCI structure. The UE shall construct the SUCI with the following data fields: SUPI Type, Home Network Identifier, Routing Indicator, Protection Scheme Identifier, Home Network Public Key Identifier, and Scheme Output. The format of the Home Network Identifier depends on the SUPI type. The format of the Scheme Output depends on the Protection Scheme. The Scheme Output includes elliptic curve cryptography (ECC) Ephemeral Public Key, Ciphertext and MAC Tag. Specific definitions of each of the data fields can refer to relevant standard protocols and will not be detailed here.

### (3) SUPI Encryption at the UE

FIG. 3 shows ECIES-based SUPI encryption at the UE. The UE shall use the provisioned public key of the home network and newly generated ECC ephemeral public-private key pair according to the ECIES parameters provisioned by the home network to obtain an ephemeral shared key, and then calculate a fresh SUCI based on the ephemeral shared key. A more detailed description can refer to relevant standard protocols and will not be detailed here.

### (4) SUCI Decryption at the HN

FIG. 4 shows ECIES-based SUPI decryption at the HN. The ECIES scheme is employed at the home network to de-conceal the SUPI using the ephemeral public key provided by the UE in the SUCI (as shown in FIG. 2) and the private key of the home network. A more detailed description can refer to relevant standard protocols and will not be detailed here.

### (5) KEM

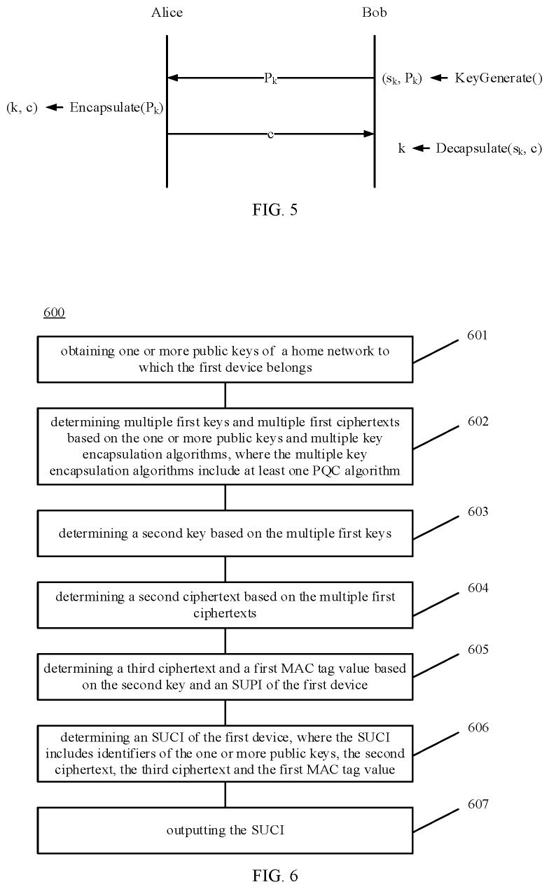

A KEM is a way of key exchange. FIG. 5 shows the KEM.

Referring to FIG. 5, the KEM is a triple of algorithms K=(KeyGenerate, Encapsulate, Decapsulate) and a corresponding key space K. At step one, Bob shall generate a public-secret key pair by using the probabilistic key generation algorithm KeyGenerate and provide the public key Pₖ to Alice. The KeyGenerate returns a public-secret-key-pair (Pₖ, sₖ). At step two, after receiving the public key Pₖ, Alice shall obtain a ciphertext c as well as a key k € K by using the probabilistic encapsulation algorithm Encapsulate and provide the ciphertext c to Bob. The Encapsulate takes as input a public key Pₖ and outputs the ciphertext c and k. At step three, after receiving the ciphertext c, Bob shall obtain k by using the deterministic decapsulation algorithm Decapsulate. The Decapsulate takes as input a secret key sₖ and the ciphertext c and returns k€K or denoting failure.

As described in the background part above, if the public key encryption scheme used were broken, the public key encryption scheme would offer no privacy protection for the subscriber. Moreover, the public key encryption scheme is vulnerable to post-quantum threats.

To solve the problem above, embodiments of the present disclosure provide a method and an apparatus for communications with PQC, which are helpful to provide privacy in a post-quantum environment.

The embodiments of the present disclosure propose to use quantum-safe algorithms to preserve the privacy of the subscriber. Further, the embodiments of the present disclosure propose to use multiple quantum-safe algorithms or hybrid quantum-safe algorithms, as combining two or more safe-algorithms can be secure as long as one of the two or more safe-algorithms is secure. Based on the embodiments of the present disclosure, keying materials, such as the ephemeral shared key in FIG. 3 and FIG. 4, can be derived from the two or more secret values established by different key establishment primitives (i.e. different safe-algorithms). The embodiments of the present disclosure also provide a new structure for the SUCI and an elementary file for USIM service (EF_{UST}) based on the multiple quantum-safe algorithms or the hybrid quantum-safe algorithms. Hybrid modes may be an initial step for the migration to post-quantum primitives.

The following describes SUPI encapsulation in the proposed solution of the present disclosure.

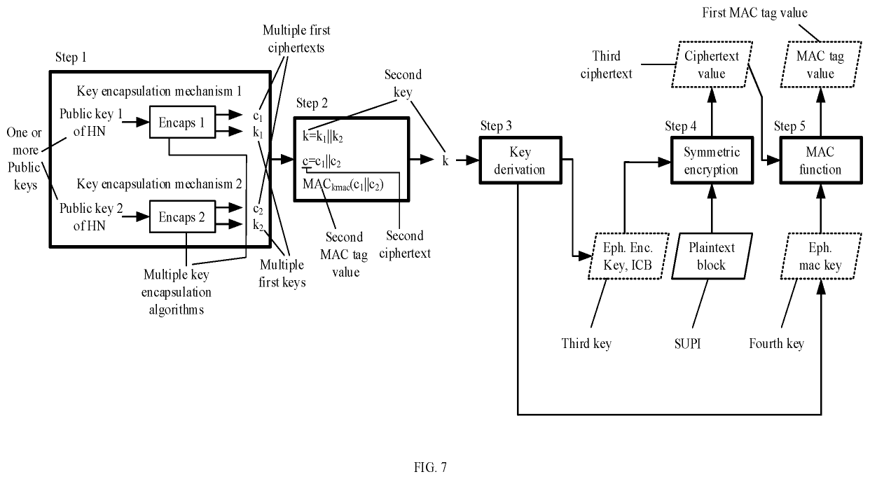

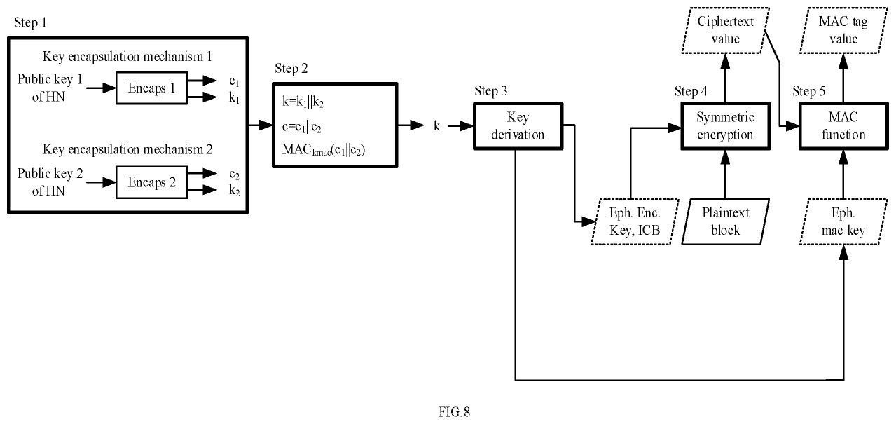

FIG. 6 is a schematic diagram of a communication method 600. The method 600 may be performed by a first device for encryption. Unless otherwise specified, the first device may refer to the first device itself or an apparatus that supports the function of the first device. As an example, the first device can be the UE in FIG. 1 or any other device requiring SUCI encryption, such as a smart card, a universal integrated circuit card (UICC), or an embedded UICC (eUICC). The method 600 further includes the following steps.

At step 601, the first device obtains one or more public keys of a home network to which the first device belongs.

As an example, the one or more public keys may be one public key. As another example, the one or more public keys may include multiple different public keys.

In a possible implementation, the one or more public keys are provisioned.

At step 602, the first device determines multiple first keys and multiple first ciphertexts based on the one or more public keys and multiple key encapsulation algorithms, where the multiple first keys are in one-to-one correspondence with the multiple first ciphertexts, and each of the multiple first ciphertexts is encrypted based on the corresponding first key.

The multiple key encapsulation algorithms include at least one quantum-safe algorithm.

As an example, all the multiple key encapsulation algorithms are quantum-safe algorithms. In this case, the approach provided in the embodiments of this disclosure may be referred to as a multi-quantum-safe approach.

As another example, a part of the multiple key encapsulation algorithms are quantum-safe algorithms. In this case, the approach provided in the embodiments of this disclosure may be referred to as a hybrid quantum-safe approach. In an example of two key encapsulation algorithms, one of the two key encapsulation algorithms can be an algorithm that is widely used, such as an algorithm approved either from National Institute of Standards and Technology (NIST) (e.g. elliptic-curve Diffie-Hellman (ECDH)), International Organization for Standardization (ISO) (e.g. SM2), or a standardization algorithm that is region/country specific, and another can be a quantum-safe algorithm which is intended to be adopted widely in the future.

The quantum-safe algorithms mentioned here can be post-quantum safe algorithms, such as PQC algorithms.

The one or more public keys may be used as inputs of the multiple key encapsulation algorithms. In a case that the one or more public keys are one public key, the multiple key encapsulation algorithms use the same public key. In a case that the one or more public keys include multiple different public keys, the multiple key encapsulation algorithms may use different public keys.

In a possible implementation, each of one or more public keys may be used as a public key Pₖ, each of the multiple first keys may be used as a key k and each of the multiple first ciphertexts may be used as a ciphertext c in the KEM shown in FIG. 5.

At step 603, the first device determines a second key based on the multiple first keys.

In a possible implementation, the first device determines the second key by processing the multiple first keys with a first function, where the first function includes at least one of the following functions: a hash function, a concatenation function or a PRF.

In another possible implementation, the first device determines the second key based on the multiple first keys and the multiple first ciphertexts. As an example, the first device determines the second key by hash concatenating of each of the multiple first keys and its corresponding first ciphertext to obtain multiple hash results and concatenating the multiple hash results.

At step 604, the first device determines a second ciphertext by concatenating the multiple first ciphertexts.

At step 605, the first device determines a third ciphertext and a first MAC tag value based on the second key and a SUPI of the first device.

In a possible implementation, the first device may determine the third ciphertext and the first MAC tag value by deriving a third key and a fourth key from the second key, determining the third ciphertext by encrypting the SUPI of the first device with the third key and determining the first MAC tag value based on the third ciphertext and the fourth key.

At step 606, the first device determines an SUCI of the first device, where the SUCI includes identifiers of the one or more public keys, the second ciphertext, the third ciphertext and the first MAC tag value.

At step 607, the first device outputs the SUCI.

In a possible implementation, the first device transmits the SUCI to a second device. As an example, the first device transmits the SUCI to the UDM for initial registration.

Thus, in the method 600, keying materials can be derived from multiple first keys established by multiple different key encapsulation algorithms. Combining multiple different key encapsulation algorithms can be secure as long as one of the multiple different key encapsulation algorithms is secure. Therefore, the method 600 is helpful to provide privacy in a post-quantum environment. Moreover, the multiple key encapsulation algorithms include at least one quantum-safe algorithm so that the method 600 can secure the SUPI encapsulation at the first device from quantum attacks.

In other embodiments of this disclosure, the SUCI further includes a second MAC tag value for verifying the second ciphertext, and the method 600 further includes determining the second MAC tag value based on the second ciphertext. As the second ciphertext can be verified based on the second MAC tag value, this embodiment can provide a better privacy in a post-quantum environment.

In other embodiments of this disclosure, the SUCI further includes a protection scheme identifier indicating a first protection scheme, where the first protection scheme is a PQC protection scheme or a PQC hybrid algorithm protection scheme, and outputs of the first protection scheme include the second ciphertext, the third ciphertext and the first MAC tag value. When the SUCI includes the second MAC tag value, and the outputs of the first protection scheme further include the second MAC tag value.

In other embodiments of this disclosure, an EF_{UST} of the first device includes a first service, where a value of the first service indicates that the first device supports PQC SUCI service.

In other embodiments of this disclosure, the EF_{UST} of the first device further includes a second service, where a value of the second service is used to indicate whether the first device supports perform calculation of the PQC SUCI service by the USIM.

The following will describe some specific embodiments of the generation of the SUCI at a UE in detail in conjunction with FIG. 7 to FIG. 10. FIG. 7 to FIG. 10 take the combination of two key encapsulation algorithms as an example. In FIG. 7 to FIG. 10, two KEMs are employed in place of Diffie-Hellman for SUCI generation at the UE. The two key encapsulation algorithms can be two encapsulation algorithms in KEM1 and KEM2 respectively. The variations of KEM1 and KEM2 can be either of the following:
One of them can be an algorithm approved either from NIST (e.g., ECDH), ISO (e.g., SM2), or a standardization algorithm that is region/country specific and another can be PQC.
Both of them can be PQC.

FIG. 7 shows a relationship between the specific embodiments and the method 600. Further, public key 1 of the HN and public key 2 of the HN imply the one or more public keys. KEM1 and KEM2 imply the multiple key encapsulation algorithms. k₁ and k₂ imply the multiple first keys. c₁ and c₂ imply the multiple first ciphertexts. k implies the second key. c implies the second ciphertext. The ciphertext value implies the third ciphertext. The MAC tag value implies the first MAC tag value. MAC_{kmac} (c₁∥c₂) implies the second MAC tag value. The ephemeral encapsulation key (Eph. Enc. key) implies the third key. The ephemeral mac key (Eph. mac. key) implies the fourth key. The plaintext block implies the SUPI of the first device.

### Embodiment 1: SUCI Concatenation

The ephemeral shared key generation in FIG. 4 can be replaced by a key which is generated by concatenating two keys from KEM1 and KEM2.

FIG. 8 shows concealing with concatenation using two KEMs at a UE. The ephemeral shared key generation (i.e. Step 1 to Step 2) in FIG. 4 is replaced by Step 1 and Step 2 in FIG. 8. In FIG. 8, k is generated by concatenating the two keys (k₁, k₂) respectively from KEM1 and KEM2. Two KEMs are employed and k is obtained by k=k₁∥k₂. Two ciphertexts (c₁, c₂) respectively from KEM1 and KEM2 are concatenated to obtain a final ciphertext c, that is, c=c₁∥c₂. The symbol “∥” indicates a concatenation. Additionally, a MAC_{kmac} for verifying the final ciphertext c is determined based on the final ciphertext c, that is, MAC_{kmac} (c₁∥c₂). k is then input to the key derivation function and the procedure of symmetric key encryption remains similar to the prior procedure in FIG. 4. The final outputs of the concealing with concatenation using two KEMs at the UE include the ciphertext c=c₁∥c₂, MAC_{kmac} (c₁∥c₂), a Ciphertext value from Step 4 and a Mac tag value from Step 5.

### Embodiment 2: SUCI Hash Concatenation

The ephemeral shared key generation in FIG. 4 can be replaced by a key which is generated by hash concatenating the keys from KEM1 and KEM2.

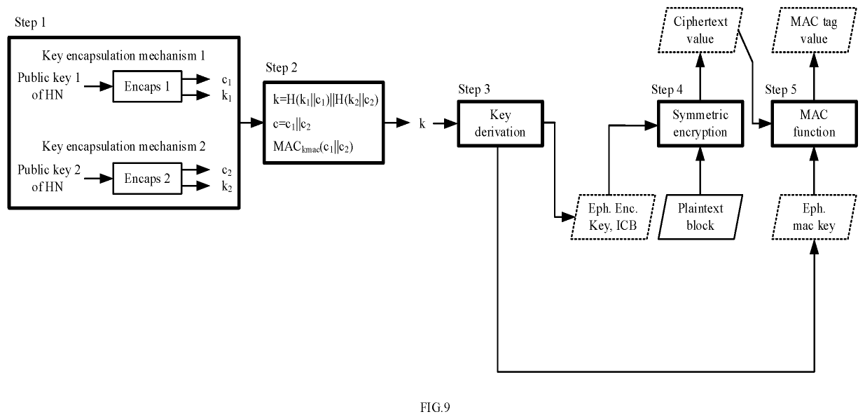

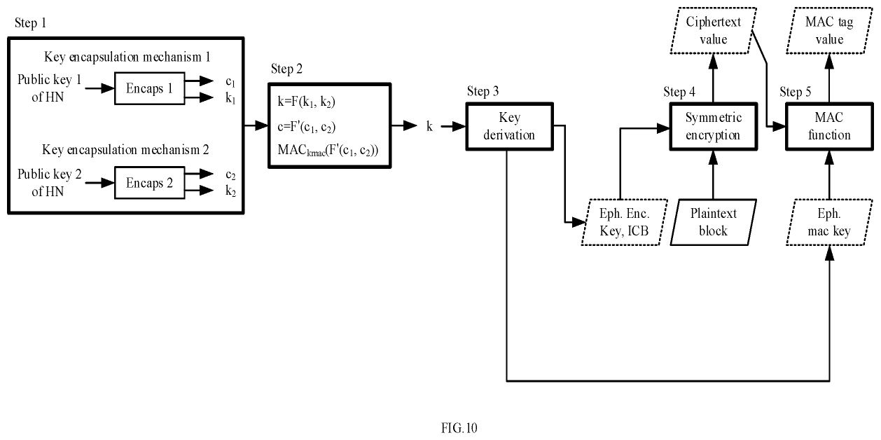

FIG. 9 shows concealing with hash concatenation using two KEMs at a UE. The ephemeral shared key generation (i.e. Step 1 to Step 2) in FIG. 4 can be replaced by Step 1 and Step 2 in FIG. 9. In FIG. 9, two KEMs are employed and k is generated with an approach where the keys and the ciphertexts of the two KEMs are hash concatenated. k is obtained by k=H (k₁∥c₁)∥H (k₂∥c₂). Two ciphertexts (c₁, c₂) respectively from KEM1 and KEM2 are concatenated to obtain a final ciphertext c, that is, c=c₁∥c₂. The symbol “∥” indicates a concatenation. The Function H corresponds to Hash. Additionally, a MAC_{kmac} for verifying the final ciphertext c is determined based on the final ciphertext c, that is, MAC_{kmac} (c₁∥c₂). k is then input to the key derivation function and the procedure of symmetric key encryption remains similar to the prior procedure in FIG. 4. The final outputs of the concealing with hash concatenation using two KEMs at the UE include the ciphertext c=c₁∥c₂, MAC_{kmac} (c₁∥c₂), a Ciphertext value from Step 4 and a Mac tag value from Step 5.

Moreover, k can also be derived by k=H (k₁∥k₂). Different combinations of concatenation can be formed.

### Embodiment 3: SUCI KEM General

In this embodiment, a general approach to derive k is provided.

FIG. 10 shows concealing with the general approach at a UE. The ephemeral shared key generation (i.e. Step 1 to Step 2) in FIG. 4 can be replaced by Step 1 and Step 2 in FIG. 10. In FIG. 10, two KEMs are employed and k is obtained by k=F (k₁, k₂). As an example, the Function F may correspond to Hash, concatenation, or a PRF. A final ciphertext c is obtained by c=F′ (c₁, c₂). As an example, the Function F′ may corresponds to concatenation. Additionally, a MAC_{kmac} for verifying the final ciphertext c is determined based on the final ciphertext c, that is, MAC_{kmac} (F′ (c₁, c₂)). k is then input to the key derivation function and the procedure of symmetric key encryption remains similar to the prior procedure in FIG. 4. The final outputs of the concealing with hash concatenation using two KEMs at the UE include the ciphertext c=c₁∥c₂, MAC_{kmac} (F′ (c₁, c₂)), a Ciphertext value from Step 4 and a Mac tag value from Step 5.

The following will describe a new SUCI structure provided by the embodiments of this disclosure. Compared with the SUCI structure in FIG. 2, the following data fields are updated to form the new SUCI structure: a Protection Scheme Identifier, a Home Network Public Key Identifier, and a Scheme Output.

### 1) Protection Scheme Identifier

In the current standards, each protection scheme is identified by a Protection Scheme Identifier. The Protection Scheme Identifiers are as follows.
null-scheme 0x0;
Profile 0x1;
Profile 0x2.

The values 0x3-0xB are reserved for future standardized protection schemes. The values 0xC-0xF are reserved for proprietary protection schemes specified by the home operator.

In the embodiments of this disclosure, the Protection Scheme Identifier can be extended to include the following profiles.
Profile 0x3-PQC Hybrid Algorithm 1, e.g. Kyber+ECC;
Profile 0x4-PQC Hybrid Algorithm 2, e.g. NTRU+ECC;
Profile 0x5-PQC Algorithm 1, e.g. Kyber;
Profile 0x6-PQC Algorithm 2, e.g. NTRU.

Profile 0x3 and Profile 0x4 are related to the hybrid approach which includes at least one post-quantum-safe algorithms and at least one traditional-safe algorithm. Profile 0x5 and Profile 0x6 are related to the multiple approach which includes only at least two post-quantum-safe algorithms.

### 2) Home Network Public Key Identifier

One or more home network public key identifiers are used for the one or more public keys in KEMs.

### 3) Scheme Output

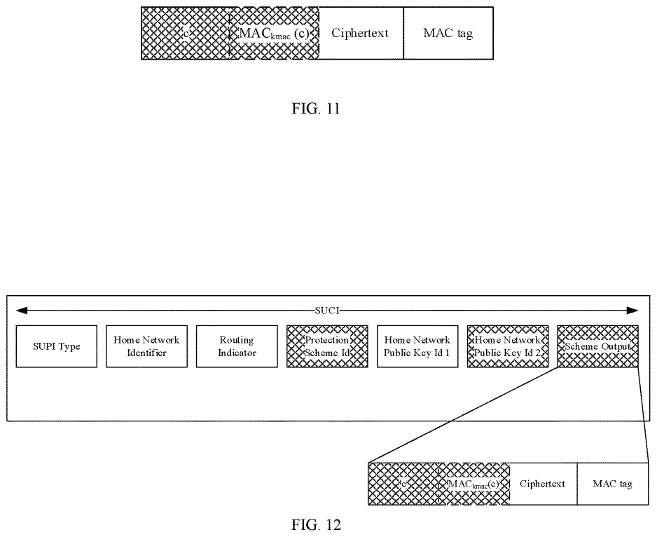

In an example of the combination of two key encapsulation algorithm, the updated Scheme Output will be as follows as shown in FIG. 11. The updated Scheme Output includes ciphertext c, MAC_{kmac} (c), a Ciphertext value and a Mac tag value. It should be understood that the MAC_{kmac} (c) is optional.

In a possible implementation, the ECC Ephemeral Public Key is replaced by the ciphertext c and the MAC_{kmac} (c).

According to FIG. 11, FIG. 12 represents one form of the new SUCI structure.

The following will describe a new elementary file for USIM service table (EF_{UST}) provided by the embodiments of this disclosure. This new EF_{UST} includes services for PQC SUCI.

Table 1 represents an EF_{UST}.

TABLE 1
EF_{UST}

| | | |
|---|---|---|
| Identifier: ‘6F38’ | Structure: transparent | Mandatory |
| SFI: ‘04’ | | |

| | |
|---|---|
| File size: X bytes, (X >= 1) | Update activity: low |

Access Conditions:

| | |
|---|---|
| READ | PIN |
| UPDATE | ADM |
| DEACTIVATE | ADM |
| ACTIVATE | ADM |

| Bytes | Description | M/O | Length |
|---|---|---|---|
| 1 | Services n°1 to n°8 | M | 1 byte |
| 2 | Services n°9 to n°16 | O | 1 byte |
| 3 | Services n°17 to n°24 | O | 1 byte |
| 4 | Services n°25 to n°32 | O | 1 byte |
| etc | | | |
| X | Services n°(8X-7) to n°(8X) | O | 1 byte |

This EF_{UST} indicates which services are available. If a service is not indicated as available in the USIM, the ME shall not select this service.

In a possible implementation, Up-to Service n^{o} 145 is defined in 3GPP and the services for PQC SUCI can start from 153. The service for PQC SUCI starts from 153 as it is the start of a new byte. Coding 1 bit is used to code each service:
bit=1: service available;
bit=0: service not available.

Services for SUCI in the current standards are defined as follows as shown in Table 2.

TABLE 2
Services for SUCI

| | |
|---|---|
| Services n°124 | Subscription identifier privacy support |
| Services n°125 | SUCI calculation by the USIM |

According to the current way to define the services, the services for PQC SUCI are defined as follows as shown in Table 3.

TABLE 3
Services for PQC SUCI

| | |
|---|---|
| Services n°153 | PQC support |
| Services n°154 | PQC SUCI calculation by the USIM |

Service n^{o} 153 indicates the PQC support. If this bit=1 then PQC is supported else PQC is not supported. If Service n^{o} 153=1 only then Service n^{o} 154 is relevant.

Service n^{o} 154 indicates the PQC SUCI calculation is done by USIM if the bit=1, else the PQC SUCI calculation is done by the ME.

The following describes SUPI decapsulation in the proposed solution of the present disclosure.

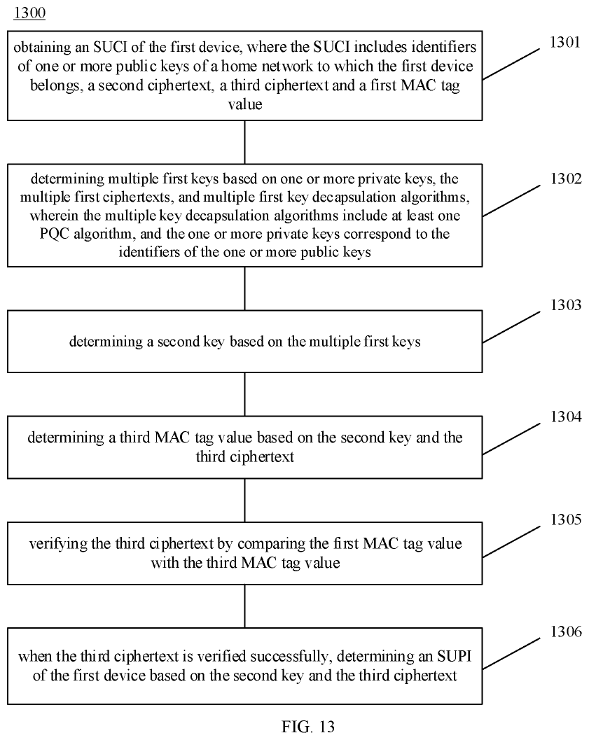

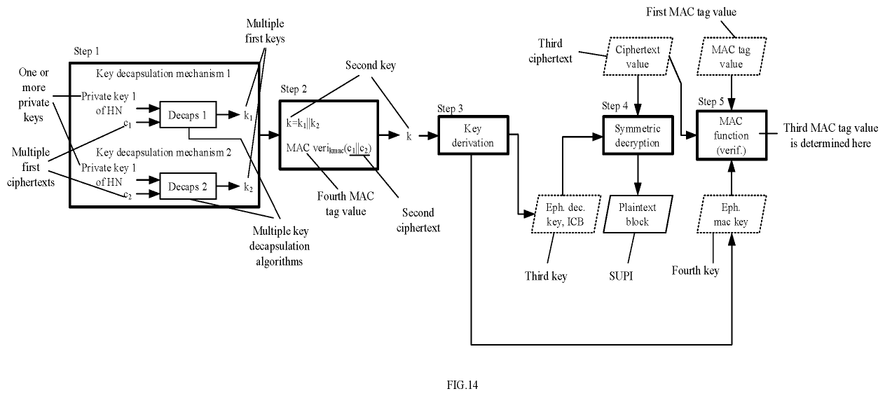

FIG. 13 is a schematic diagram of a communication method 1300. The method 1300 may be performed by a second device for decryption. Unless otherwise specified, the second device may refer to the second device itself or an apparatus that supports the function of the second device. As an example, the second device can be the UDM in FIG. 1 or any other device requiring SUCI decryption, such as ARPF or a SIDF. The method 1300 further includes the following steps. At step 1301, the second device obtains an SUCI of a first device.

The SUCI of the first device may be generated in a way described in the method 600. The SUCI of the first device includes identifiers of one or more public keys of a home network to which the first device belongs, a second ciphertext, a third ciphertext and a first MAC tag value. The second ciphertext includes multiple first ciphertexts.

In a possible implementation, the second device may receive the SUCI from the first device.

At step 1302, the second device determines multiple first keys based on one or more private keys, the multiple first ciphertexts, and multiple key decapsulation algorithms.

The one or more private keys correspond to the identifiers of the one or more public keys in the SUCI. A detailed description of the one or more public keys may refer to Step 601.

The multiple key decapsulation algorithms correspond to the multiple key encapsulation algorithms, and include at least one quantum-safe algorithm. A detailed description of the multiple key decapsulation algorithms may refer to Step 602.

The one or more private keys and the multiple first ciphertexts may be used as inputs of the multiple key decapsulation algorithms. In a case that the one or more private keys are one private key, the multiple key decapsulation algorithms use the same private key. In a case that the one or more private keys include multiple different private keys, the multiple key decapsulation algorithms may use different private keys.

In a possible implementation, each of one or more private keys may be used as a private key sₖ, each of the multiple first keys may be used as a key k and each of the multiple first ciphertexts may be used as a ciphertext c in the KEM shown in FIG. 5.

At step 1303, the second device determines a second key based on the multiple first keys.

A detailed description of Step 1303 may refer to Step 603.

At step 1304, the second device determines a third MAC tag value based on the second key and the third ciphertext.

The way of determining the third MAC tag value by the second device is the same as that the first device determines the first MAC tag value.

At step 1305, the second device verifies the third ciphertext by comparing the first MAC tag value with the third MAC tag value.

When the third MAC tag value matches with the first MAC tag value, the third ciphertext is verified successfully. When the third MAC tag value does not match with the first MAC tag value, the third ciphertext fails to be verified.

At step 1306, when the third ciphertext is verified successfully, the second device determines a SUPI of the first device based on the second key and the third ciphertext.

Thus, in the method 1300, keying materials can be derived from multiple first keys established by multiple different key decapsulation algorithms. Combining multiple different key decapsulation algorithms can be secure as long as one of the multiple different key decapsulation algorithms is secure. Therefore, the method 1300 is helpful to provide privacy in a post-quantum environment. Moreover, the multiple key decapsulation algorithms include at least one quantum-safe algorithm so that the method 1300 can secure the SUPI decapsulation at the second device from quantum attacks.

In other embodiments of this disclosure, the SUCI further includes a second MAC tag value for verifying the second ciphertext, and the method 1300 further includes determining a fourth MAC tag value based on the second ciphertext received in the SUCI and verifying the second ciphertext by comparing the second MAC tag value with the fourth MAC tag value. As the second ciphertext can be verified based on the second MAC tag value, this embodiment can provide a better privacy in a post-quantum environment.

In other embodiments of this disclosure, the method 1300 further includes that the second device derives a third key and a fourth key from the second key. Based on this, the second device determines the SUPI of the first device by decrypting the third ciphertext with the third key and determines the third MAC tag value based on the fourth key.

The following will describe some specific embodiments of de-concealing of the SUCI at an HM in detail in conjunction with FIG. 14 to FIG. 17. FIG. 14 to FIG. 17 correspond to FIG. 7 to FIG. 10 respectively. FIG. 14 to FIG. 17 take the combination of two key encapsulation algorithms as an example. In FIG. 14 to FIG. 17, two KEMs are employed in place of Diffie-Hellman for SUCI de-concealing at the HM. The two key decapsulation algorithms can be two Decapsulate algorithms in KEM1 and KEM2 respectively.

FIG. 14 shows a relationship between the specific embodiments and the method 1300. Further, private key 1 of the HN and private key 2 of the HN imply the one or more private keys. KEM1 and KEM2 imply the multiple key decapsulation algorithms. k₁ and k₂ imply the multiple first keys. Cand c₂ imply the multiple first ciphertexts. k implies the second key. The ciphertext value implies the third ciphertext. The MAC tag value implies the first MAC tag value. The MAC_{verikmac} (c₁∥c₂) implies the fourth MAC tag value. The ephemeral encapsulation key (Eph. Enc. key) implies the third key. The ephemeral mac key (Eph. mac. key) implies the fourth key. The plaintext block implies the SUPI of the first device.

### Embodiment 4

The ephemeral shared key generation in FIG. 4 can be replaced by a key which is generated by concatenating two keys from KEM1 and KEM2.

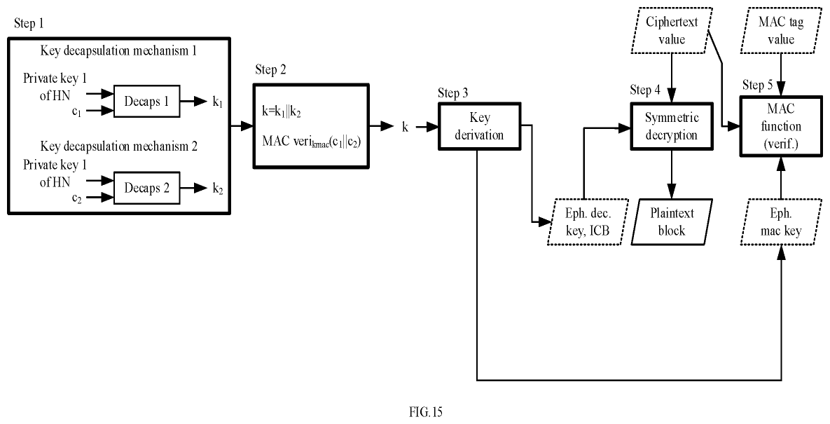

FIG. 15 represents SUCI de-concealing with two KEMs at an HM. For the de-capsulation mechanism, two private keys of the home network of the respective public keys and two ciphertexts that are transmitted in the SUCI from the first device to the home network are used. k is obtained by k=k₁∥k₂ and the ciphertext c transmitted in the SUCI is verified. k is then input to the key derivation function and the procedure of symmetric key decryption remains similar to the prior procedure in FIG. 4.

### Embodiment 5

The ephemeral shared key generation in FIG. 4 can be replaced by a key which is generated by hash concatenating two keys from KEM1 and KEM2.

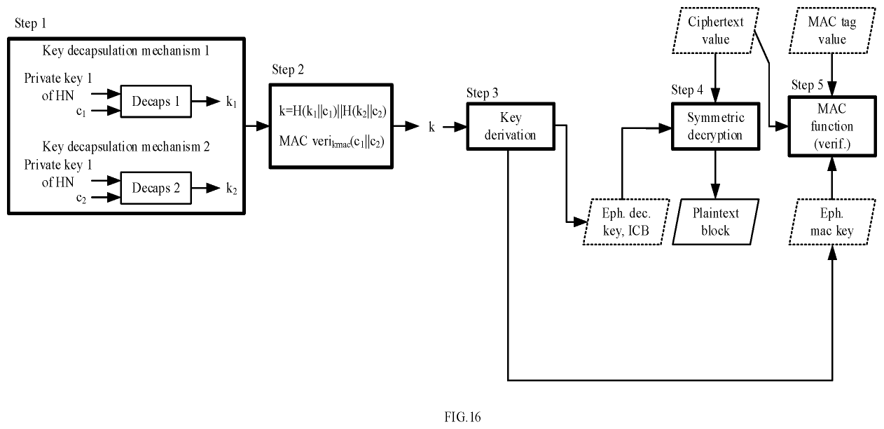

FIG. 16 represents another SUCI de-concealing with two KEMs at an HM. For the de-capsulation mechanism, two private keys of the home network of the respective public keys and two ciphertexts that are transmitted in the SUCI from the first device to the home network are used. k is obtained by k=H (k₁∥c₁)∥H (k₂∥c₂) and the ciphertext c transmitted in the SUCI is verified. k is then input to the key derivation function and the procedure of symmetric key decryption remains similar to the prior procedure in FIG. 4.

Moreover, k can also be derived by k=H (k₁∥k₂). Different combinations of concatenation can be formed.

### Embodiment 6

In this embodiment, a general approach to derive k is provided.

FIG. 17 represents a general SUCI de-concealing with two KEMs at an HM. For the de-capsulation mechanism, two private keys of the home network of the respective public keys and two ciphertexts that are transmitted in the SUCI from the first device to the home network are used. k is obtained by k=F (k₁, k₂) and the ciphertext c transmitted in the SUCI is verified. k is then input to the key derivation function and the procedure of symmetric key decryption remains similar to the prior procedure in FIG. 4.

It should be noted that the above embodiments of this disclosure may be implemented independently or together in an appropriate way.

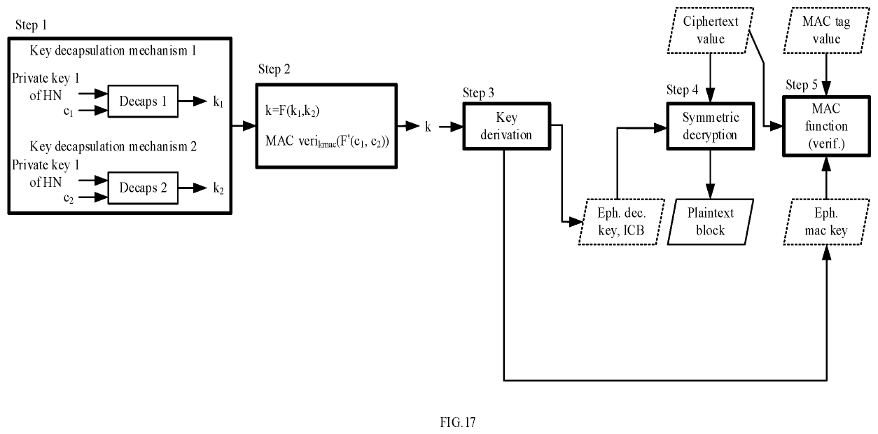

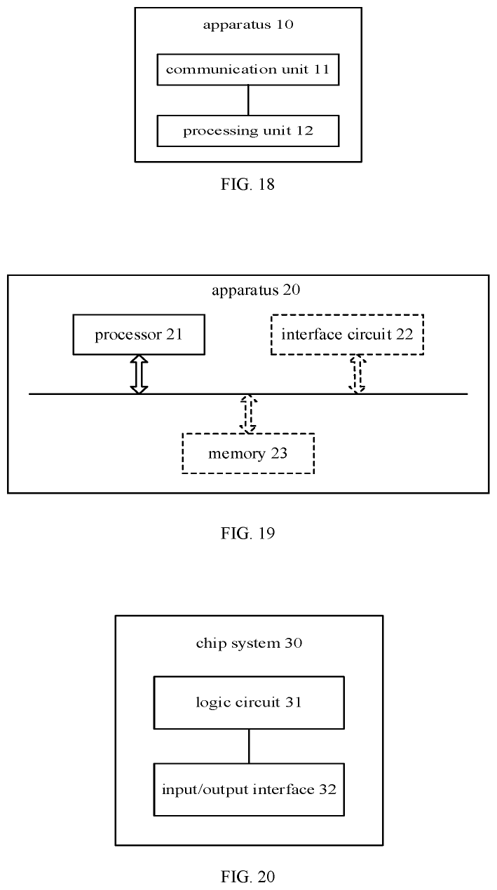

The method provided in this disclosure is described in detail above in conjunction with FIGS. 6 to 17. The apparatus embodiments of this disclosure will be described in detail below in conjunction with FIG. 18 to FIG. 20.

It is understood that in order to implement the functions in the above embodiments, the apparatus in FIG. 18 to FIG. 20 may include the corresponding hardware architecture and/or software modules that perform each of the functions.

FIG. 18 and FIG. 19 provide possible structural diagrams of the apparatus. The apparatus may be used to implement the functions of the first device or the second device of the method embodiments described above, and thus the apparatus is able to achieve the beneficial effects of the method embodiments described above.

As shown in FIG. 18, an apparatus 10 includes a communication unit 11 and a processing unit 12.

When the apparatus 10 is used to implement the functions of the first device in the method embodiments described above, the communication unit 11 is used for performing the sending and receiving Steps, such as Step 601 and Step 607, and the processing unit 12 is used for performing the processing steps, such as Step 602 to Step 606.

When the apparatus 10 is used to implement the functions of the second device in the method embodiments described above, the communication unit 11 is used for performing the sending and receiving Steps, such as Step 1301, and the processing unit 12 is used for performing the processing steps, such as Step 1302 to Step 1306.

More detailed descriptions of the communication unit 11 and the processing unit 12 may refer to the relevant descriptions in the method embodiments described above, and not be repeated here.

As shown in FIG. 19, an apparatus 20 may include a processor 21. The processor 21 is coupled to a memory 23 which is used to store instructions. While the apparatus 20 is used to implement the method described above, the processor 21 is used to execute the instructions in the memory 23 to implement the functions of the processing unit 12 described above.

In an embodiment, the apparatus 20 further includes the memory 23.

In an embodiment, the apparatus 20 further includes an interface circuit 22. The processor 21 is coupled to the interface circuit 22. Understandably, the interface circuit 22 may be a transceiver or input/output (I/O) interface. When the apparatus 20 is used to implement the method described above, the processor 21 is used to execute the instructions to implement the functions of the processing unit 12 and the interface circuit 22 is used to implement the functions of the communication unit 11.

Illustratively, when the apparatus 20 is a chip applied in the first device or the second device, the chip implements the function of the first device or the second device. The chip receives information from other modules (such as a radio frequency module or an antenna) in the first device or the second device, and the information is sent to the first device or the second device by another device. In an embodiment, the chip sends information to other modules (such as a radio frequency module or an antenna) in the first device or the second device, and the information is sent to another device.

FIG. 20 represents a schematic illustration of a chip system 30 provided by the embodiments of this disclosure. The chip system 30 (alternatively, the processing system) includes a logic circuit 31 and an I/O interface 32.

The logic circuit 31 can be the processing circuit in the chip system 30. The logic circuit 31 can be coupled to a storage unit and call instructions in the storage unit, so that the chip system 30 can realize the methods and functions of each embodiment of the disclosure.

The input/output interface 32 can be the input and output circuit in the chip system 30 to output the information processed by the chip system 30, or to input the data or signaling information to be processed into the chip system 30 for processing.

As a scheme, the chip system 30 is used to implement the operations performed by the first device or the second device in the method embodiments above.

For example, a logic circuit 31 is used to implement the process-related operations performed by the first device or the second device in the method embodiments above. The input/output interface 32 is used to implement the transmit and/or receive related operations performed by the first device or the second device in the method embodiments above.

The embodiments of the disclosure also provide an apparatus for communications with PQC, which includes one or more processors, where the one or more processors are configured to execute a computer program or instructions stored in a memory to implement any of the methods provided by the above-mentioned method embodiments.

The embodiments of the disclosure also provide a processor which is configured to execute a computer program or instructions stored in a memory to implement any of the methods provided by the above-mentioned method embodiments.

The embodiments of the disclosure also provide a computer-readable medium on which a program or instructions are recorded, where the program or the instructions, when executed, enables a computer to implement any of the methods provided by the above-mentioned method embodiments.

The embodiments of the disclosure also provide a computer program product, where the computer program product includes instructions to implement any of the methods provided by the above-mentioned method embodiments.

The embodiments of the disclosure also provide a computer program, where the computer program, when executed, enables a computer to implement any of the methods provided by the above-mentioned method embodiments.

The embodiments of the disclosure also provide a chip, where the chip includes at least one processor and a communication interface, where the at least one processor is used to obtain a computer program or instructions stored in a memory through the communication interface to implement any of the methods provided by the above-mentioned method embodiments.

The embodiments of the disclosure also provide a communication system, where the communication system includes the first device and/or the second device mentioned above.

In the embodiments of this disclosure, “and/or” describes an association relationship between associated objects and represents that three relationships may exist. For example, A and/or B may represent the following three cases: Only A exists, both A and B exist, and only B exists. The character “/” generally indicates an “or” relationship between the associated objects. “multiple A” means two or more A. “At least one” means one or more. “At least one of A and B”, similar to “A and/or B”, describes an association relationship between associated objects and represents that three relationships may exist. For example, at least one of A and B may represent the following three cases: Only A exists, both A and B exist, and only B exists.

The technical terms such as “ephemeral shared key” may be not limited by a specific name, and may also be other names.

Besides, the use of a singular form of “a”, “an” and “the” in the embodiments of the present disclosure and the claims appended hereto is also intended to include a plural form, unless otherwise clearly indicated herein by context.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this disclosure.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this disclosure, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

In addition, function units in the embodiments of this disclosure may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this disclosure may be implemented in the form of a software product. The software product is stored in a storage medium, and includes several instructions for instructing a computer device (which may be a personal computer, a server, a network device, or the like) to perform all or some of the steps of the methods described in the embodiments of this disclosure. The foregoing storage medium includes any medium that can store program code, such as a Universal Serail Bus (USB) flash drive, a removable hard disk, a read-only memory (ROM), a random-access memory (RAM), a magnetic disk, an optical disc or the like.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments. In addition, functional units in the embodiments of this disclosure may be integrated into one processing unit, or each of the units may exist alone physically, or two or more units are integrated into one unit.

The foregoing descriptions are merely specific embodiments of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method comprising:
determining first keys and multiple first ciphertexts based on one or more public keys and key encapsulation algorithms, wherein the key encapsulation algorithms comprise at least one post-quantum cryptography (PQC) algorithm, and wherein the first keys are in one-to-one correspondence with the first ciphertexts;
determining a second key based on the first keys;
determining a second ciphertext by concatenating the multiple-first ciphertexts;
determining a third ciphertext and a first message authentication code (MAC) tag value based on the second key and a subscription permanent identifier (SUPI) of a first device;
determining a subscription concealed identifier (SUCI) of the first device, wherein the SUCI comprises the second ciphertext, the third ciphertext, and the first MAC tag value; and
outputting the SUCI.

2. The method acc of claim 1, further comprising obtaining the one or more public keys, wherein the one or more public keys are of a home network to which the first device belongs.

3. The method of claim 1, further comprising encrypting each of the first ciphertexts based on a corresponding one of the first keys.

4. The method of claim 1, wherein the SUCI further comprises identifiers of the one or more public keys.

5. The method of claim 1, wherein determining the second key comprises determining the second key by processing the first keys with a first function, and wherein the first function is a concatenation function.

6. The method of claim 1, wherein the SUCI further comprises a second MAC tag value for verifying the second ciphertext, and wherein the method further comprises determining the second MAC tag value based on the second ciphertext.

7. The method of claim 1, wherein the SUCI further comprises a protection scheme identifier indicating a first protection scheme, wherein the first protection scheme is a PQC protection scheme or a PQC hybrid algorithm protection scheme, and wherein outputs of the first protection scheme comprise the second ciphertext, the third ciphertext, and the first MAC tag value.

8. A method implemented by a second device, wherein the method comprises:
obtaining a subscription concealed identifier (SUCI) of a first device, wherein the SUCI comprises a second ciphertext, a third ciphertext, and a first message authentication code (MAC) tag value, wherein the second ciphertext comprises multiple-first ciphertexts;
determining first keys based on one or more private keys, the first ciphertexts, and key decapsulation algorithms, wherein the key decapsulation algorithms comprise at least one post-quantum cryptography (PQC) algorithm;
determining a second key based on the first keys;
determining a third MAC tag value based on the second key and the third ciphertext;
verifying the third ciphertext by comparing the first MAC tag value with the third MAC tag value; and
determining, in successfully verifying the third ciphertext, a subscription permanent identifier (SUPI) of the first device based on the second key and the third ciphertext.

9. The method of claim 8, wherein the SUCI further comprises first identifiers of one or more public keys wherein the one or more public keys are of a home network to which the first device belongs, and wherein the first identifiers correspond to second identifiers of the one or more private keys.

10. The method of claim 8, wherein determining the second key comprises determining the second key by processing the first keys with a first function, and wherein the first function is a concatenation function.

11. The method of claim 8, wherein the SUCI further comprises a second MAC tag value for verifying the second ciphertext, and wherein the method further comprises:
determining a fourth MAC tag value based on the second ciphertext-received and
verifying the second ciphertext by comparing the second MAC tag value with the fourth MAC tag value.

12. The method of claim 8, wherein the SUCI further comprises a protection scheme identifier indicating a first protection scheme, wherein the first protection scheme is a PQC protection scheme or a PQC hybrid algorithm protection scheme, and wherein outputs of the first protection scheme comprise the second ciphertext, the third ciphertext, and the first MAC tag value.

13. The method of claim 8, wherein the one or more public keys comprise different public keys, and wherein the one or more private keys comprise different private keys.

14. A communication apparatus, comprising:
a memory configured to store instructions; and
one or more processors, wherein when executed by the one or more process e instructions cause the communication apparatus to:
determine first keys and first ciphertexts based on one or more public keys and key encapsulation algorithms, wherein the key encapsulation algorithms comprise at least one post-quantum cryptography (PQC) algorithm, and wherein the first keys are in one-to-one correspondence with the first ciphertexts;
determine a second key based on the first keys;
determine a second ciphertext by concatenating the first ciphertexts;
determine a third ciphertext and a first message authentication code (MAC) tag value based on the second key and a subscription permanent identifier (SUPI) of a first device;
determine a subscription concealed identifier (SUCI) of the first device, wherein the SUCI comprises the second ciphertext, the third ciphertext and the first MAC tag value; and
output the SUCI.

15. The communication apparatus of claim 14, wherein when executed by the one or more processors, the instructions further cause the communication apparatus to obtain the one or more public keys, and wherein the one of more public keys are of a home network to which the first device belongs.

16. The communication apparatus of claim 14, wherein when executed by the one or more processors the instructions further cause the communication apparatus to encrypt each of the first ciphertexts based on corresponding one of the first keys.

17. The communication apparatus of claim 14, wherein the SUCI further comprises identifiers of the one or more public keys.

18. The communication apparatus of claim 14, wherein to determine the second key, when executed by the one or more processors, the instructions further cause the communication apparatus to determine the second key by processing the first keys with a first function, and wherein the first function is a concatenation function.

19. The communication apparatus of claim 14, wherein the SUCI further comprises a second MAC tag value for verifying the second ciphertext, and wherein when executed by the one or more processors the instructions further cause the communication apparatus to determine the second MAC tag value based on the second ciphertext.

20. The communication apparatus of claim 14, wherein the SUCI further comprises a protection scheme identifier indicating a first protection scheme, wherein the first protection scheme is a PQC protection scheme or a PQC hybrid algorithm protection scheme, and wherein outputs of the first protection scheme comprise the second ciphertext, the third ciphertext and the first MAC tag value.
